(19) United States
(12) Patent Application Publication
(10) Pub. No.: US 2007/0222533 A1
(43) Pub. Date: Sep. 27, 2007

(54) Capacitance-compensated differential circuit line layout structure

(76) Inventor: Chun-Yu Lai, Taipei (TW)

Correspondence Address: PEARL COHEN ZEDEK LATZER, LLP, 1500 BROADWAY 12TH FLOOR, NEW YORK, NY, 10036, US

(21) Appl. No.: 11/387,898

(22) Filed: Mar. 24, 2006

(51) Int. Cl. H01P 3/00

(52) U.S. Cl. 333/4

(57) ABSTRACT

A capacitance-compensated differential circuit line layout structure is proposed, which is designed for use on a circuit board, such as a high-speed digital circuit board, for the layout of a pair of differential circuit lines on the high-speed digital circuit board, and which is characterized by the provision of a branched electrically-conductive pad at the bent portion of the radially-side one of the two differential circuit lines (i.e., the shorter one of the two circuit lines), for the purpose of providing the shorter one of the circuit lines with a capacitive effect that can cause a time delay to the ultra-high frequency digital signal passing therethrough, thereby eliminating the undesired effects of phase skew and signal reflection. In addition, this feature also allows the layout work of the differential pair of circuit lines to be more simplified and thus easier to implement than the prior art.

### BACKGROUND OF THE INVENTION

1. Field of the Invention

This invention relates to circuit layout technology, and more particularly, to a capacitance-compensated differential circuit line layout structure which is designed for use on a circuit board, such as a high-speed digital circuit board, for the layout of a pair of differential circuit lines on the high-speed digital circuit board.

2. Description of Related Art

With the advent of wireless digital communication technologies, such as wireless networking, mobile phones, GPS (Global Positioning System), etc., the design and manufacture of high-speed digital circuit boards that handle digital signals in the gigahertz range is in high demand in the electronics industry. In circuit layout design, high-speed digital circuit boards typically use microstrips for transmission of digital signals at ultra-high frequencies (UHF), typically in the range from 1 GHz to 3 GHz (gigahertz).

In the design of high-speed digital circuit boards, it is a common practice to provide a pair of microstrips for the transmission of a pair of differential UHF digital signals. FIG. 1 is a schematic diagram showing a circuit board 10 with a conventional differential circuit line layout structure 100. As shown, this conventional differential circuit line layout structure 100 is used for the layout of a pair of circuit lines, including a first circuit line 110 and a second circuit line 120, where the first circuit line 210 and the second circuit line 120 are separated by a predetermined distance and extend over the circuit board 10 along a curved path which includes at least one bent portion 101 (in the example of FIG. 1, four bent portions 101 are shown), and the first circuit line 110 is laid radially inside the second circuit line 120 at each of the bent portions 101. In actual application, this differential pair of circuit lines 110, 120 are used for the transmission of a pair of differential UHF digital signals from the reception point A to the terminal point B. In the differential circuit line layout structure 100, however, since the first circuit line 110 is located at a radially-inside position in relation to the second circuit line 120 at each bent portion 101, the first circuit line 110 is shorter in length than the second circuit line 120. As a result, at each bent portion 101, the digital signal transmitting on the first circuit line 110 will lead the other digital signal transmitting on the second circuit line 120, thus causing a phase skew between the two signals when they reach the terminal point B.

One solution to the foregoing problem is to provide one or more wave-shaped microstrip segments 130 in the first circuit line 110 (in the example of FIG. 1, two wave-shaped microstrip segments 130 are provided), for the purpose of increasing the overall length of the first circuit line 110. The increased length of the first circuit line 110 thus can solve the problem of phase skew.

One drawback to the provision of the above-mentioned wave-shaped microstrip segments 130, however, is that the wave-shaped microstrip segments 130 each include a series of U-shaped segments which would undesirably cause discontinuity in the transmission of the UHF digital signal over the first circuit line 110, thus resulting in signal reflections that would cause the processing circuitry (not shown) at the terminal point B to receive a weakened signal. Fundamentally, the higher is the frequency of the UHF digital signal, the higher is the reflectivity at the wave-shaped microstrip segments 130.

Still one drawback to the utilization of the above-mentioned wave-shaped microstrip segments 130 is that, since UHF digital signals are quite sensitive to the size and shape of the transmission line, the wave-shaped microstrip segments 130 should be designed with high precision in size and symmetry, For this sake, the layout work of the wave-shaped microstrip segments 130 is quite difficult and tedious to implement with current computer-aided circuit layout drawing programs. This drawback makes the differential circuit line layout structure 100 very laborious and time-consuming to realize.

### SUMMARY OF THE INVENTION

It is therefore an objective of this invention to provide a capacitance-compensated differential circuit line layout structure which can help eliminate the undesired effects of phase skew and signal reflection in the transmission of differential UHF digital signals over a differential pair of microstrips.

It is another objective of this invention to provide a capacitance-compensated differential circuit line layout structure which allows the layout work of a differential pair of microstrips to be more simplified and thus easier to implement than the prior art.

The capacitance-compensated differential circuit line layout structure according to the invention is designed for use on a circuit board, such as a high-speed digital circuit board, for the layout of a pair of differential circuit lines (i.e., microstrips) on the high-speed digital circuit board.

Structurally, the capacitance-compensated differential circuit line layout structure according to the invention comprises: (A) a pair of differential circuit lines, including a first circuit line and a second circuit line, which extend over the circuit board in a curved path and thus include at least one bent portion, wherein the first circuit line is laid radially inside the second circuit line at each bent portion; and (B) at least one branched electrically-conductive pad, which is laid beside the bent portion of the first circuit line and electrically connected to the first circuit line for providing an equivalent capacitive effect to the first circuit line.

The capacitance-compensated differential circuit line layout structure according to the invention is characterized by the provision of a branched electrically-conductive pad at the bent portion of the radially-side one of a pair of differential circuit lines (i.e., the shorter one of these two circuit lines), for the purpose of providing the shorter one of the circuit lines with a capacitive effect that can cause a time delay to the UHF digital signal passing therethrough, thereby eliminating the undesired effects of phase skew and signal reflection as in the case of the prior art. In addition, this feature also allows the layout work of the differential pair of circuit lines to be more simplified and thus easier to implement than the prior art.

### BRIEF DESCRIPTION OF DRAWINGS

The invention can be more fully understood by reading the following detailed description of the preferred embodiments, with reference made to the accompanying drawings, wherein:

FIG. 1 (PRIOR ART) is a schematic diagram showing a circuit board with a conventional layout structure for a pair of differential circuit lines;

FIG. 2: is a schematic diagram showing a circuit board which is provided with a capacitance-compensated differential circuit line layout structure according to the invention;

FIG. 3 is a schematic diagram showing the equivalent circuit of a pair of transmission lines;

FIG. 4 is a schematic diagram showing the equivalent circuit of a branched electrically-conductive pad utilized by the capacitance-compensated differential circuit line layout structure of the invention; and

FIG. 5 is a graph showing the characteristic plot of an output common noise for a preferred embodiment of the capacitance-compensated differential circuit line layout structure according to the invention.

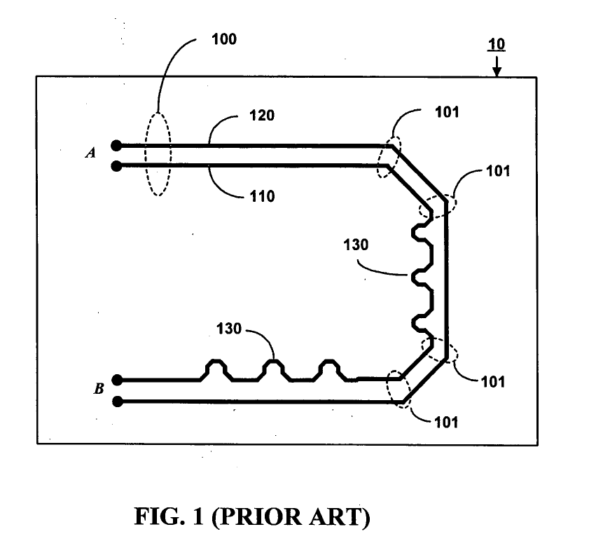

### DETAILED DESCRIPTION OF PREFERRED EMBODIMENTS

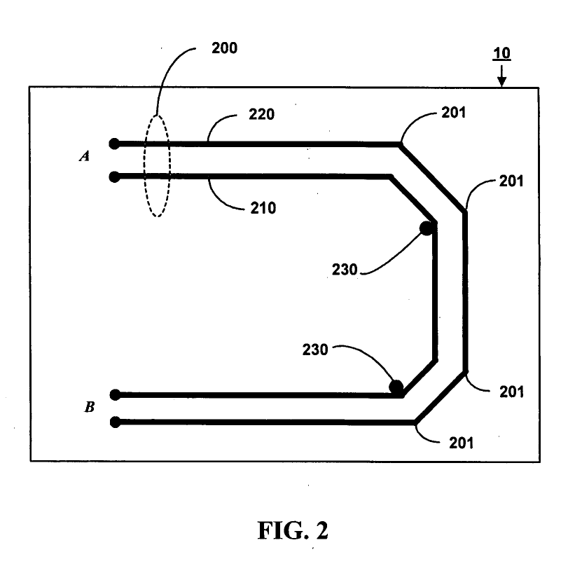

The capacitance-compensated differential circuit line layout structure according to the invention is disclosed in full details by way of preferred embodiment in the following with reference to FIG. 2 through FIG. 5.

FIG. 2 is a schematic diagram showing a preferred embodiment of the capacitance-compensated differential circuit line layout structure 200 according to the invention. As shown, the capacitance-compensated differential circuit line layout structure 200 of the invention comprises: (A) a pair of circuit lines, including a first circuit line 210 and a second circuit line 220; and (B) at least one branched electrically-conductive pad 230.

The first circuit line 210 and the second circuit line 220 are, for example, a pair of microstrips used for the transmission of ultra-high frequency signals, such as a pair of differential UHF digital signals, and which are separated by a predetermined distance and extend over the circuit board 10 along a curved path. Structurally, this differential pair of circuit lines 210, 220 includes at least one bent portion 201 (in the example of FIG. 2, four bent portions 201 are shown), and the first circuit line 210 is laid radially inside the second circuit line 220 at each of the bent portions 201. In actual application, this differential pair of circuit lines 210, 220 are used for transmitting a pair of differential UHF digital signals from the reception point A to the terminal point B.

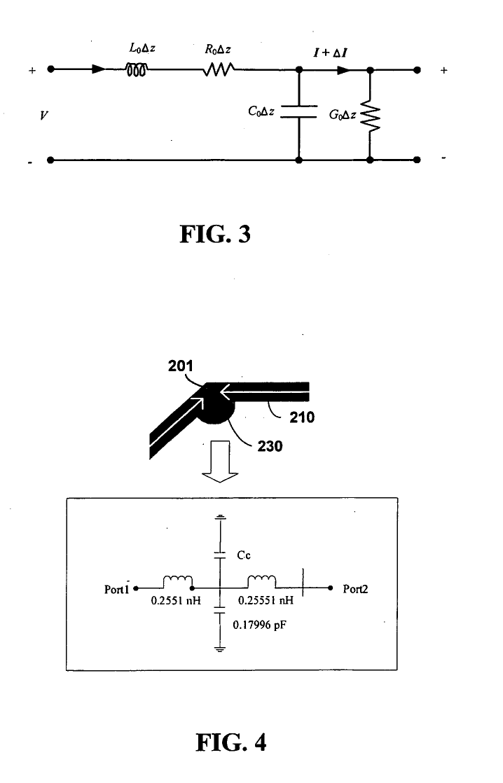

The capacitance-compensated differential circuit line layout structure 200 is characterized by the provision of at least one branched electrically-conductive pad 230 (in the example of FIG. 2, two such pads 230 are provided) at the bent portion 201 of the first circuit line 210 (i.e., the shorter one of the two circuit lines 210, 220), where the branched electrically-conductive pad 230 should be electrically connected to the first circuit line 210. This branched electrically-conductive pad 230 is intended to serve as an equivalent capacitor to provide a capacitive effect to the first circuit line 210, such that the capacitive effect can result in an increased time delay for the UHF digital signal transmitting on the first circuit line 210. In the embodiment of FIG. 2, for example, the branched electrically-conductive pad 230 is formed in a rounded shape, but other shapes are also feasible. Fundamentally, the delay time is a function of the equivalent capacitance of the branched electrically-conductive pad 230, and the equivalent capacitance is a function of the area of the branched electrically-conductive pad 230, the thickness d of the circuit board 10, and the dielectric constant of the dielectric material being used in the circuit board 10. The relationship is described in the following with reference to FIG. 3 and FIG. 4.

FIG. 3 is a schematic diagram showing the equivalent circuit of a pair of transmission lines. Assume that Δz→0, then

$$\frac{ⅆ V}{ⅆ z} = - ( {R}_{0} + jω {L}_{0} ) \cdot I$$

$$\frac{ⅆ I}{ⅆ z} = - ( {G}_{0} + jω {C}_{0} ) \cdot V$$

It can be obtained from these two differential equations that:

$$V = {V}_{+} \cdot {ⅇ}^{- γ z} + {V}_{-} \cdot {ⅇ}^{γ z}$$

$$I = \frac{1}{{Z}_{0}} ( {V}_{+} \cdot {ⅇ}^{- γ z} + {V}_{-} \cdot {ⅇ}^{γ z} )$$

$$γ = \sqrt{( {R}_{0} + jω {L}_{0} ) ( {G}_{0} + jω {C}_{0} )}$$

where

γ: propagation constant

If γ is expressed as
γ=α+jβ
then
α²−β²=R₀G₀−Ω²L₀C₀
where

α: attenuation over the transmission line per unit length;

β: phase shift over the transmission per unit length.
The characteristic impedance Z₀ is formulated as follows:

$${Z}_{0} = \sqrt{\frac{{R}_{0} + jω {L}_{0}}{{G}_{0} + jω {C}_{0}}}$$

Assume G₀=0 and R₀=0, α=0 within the non-attenuated zone, it can be obtained that:

$$β = ω \cdot \sqrt{{L}_{0} {C}_{0}}$$

$${Z}_{0} = \sqrt{\frac{{L}_{0}}{{C}_{0}}}$$

$$Since$$

$$ω = β v and$$

$$v = \frac{1}{{T}_{0}}$$

it can be obtained that the delay time T₀ is:
T₀=\sqrt{L₀C₀}

FIG. 4 is a schematic diagram showing the equivalent circuit of the branched electrically-conductive pad 230 utilized by capacitance-compensated differential circuit line layout structure 200 according to the invention. Assume that the delay time caused by the curvature of the differential pair of circuit lines 210, 220 at the bent portions 201 is T_{d}, then T_{d} is related to the equivalent capacitance C_{c} of the branched electrically-conductive pad 230 as follows:
\sqrt{LC}−\sqrt{L(C+Cc)}=T_{d}
The area A of the branched electrically-conductive pad 230 is related to C_{c} as follows:

$${C}_{C} = ɛ \frac{A}{d}$$

$$Therefore$$

$$A = \frac{d \cdot Cc}{ɛ}$$

In the case that T_{d}=0.75 ps and L=0.2551 nH, it can be obtained that C_{c}=29.19 fF. Therefore, the required area A of the branched electrically-conductive pad 230 can be obtained by knowing the thickness d of the circuit board 10 and the dielectric constant ∈ of the dielectric material being used in the circuit board 10.

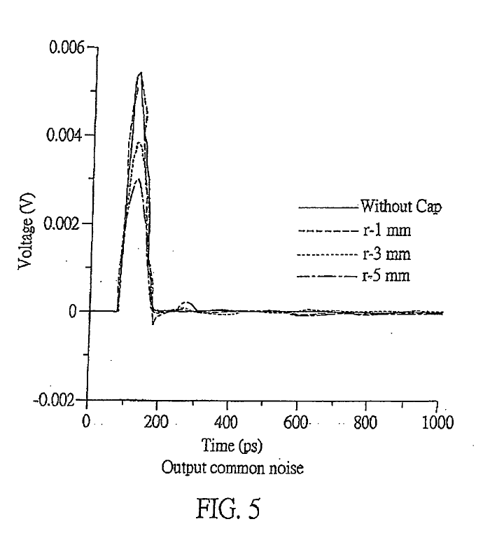

FIG. 5 is a graph showing the characteristic plot of an output common noise for a preferred embodiment of the capacitance-compensated differential circuit line layout structure 200 according to the invention. It can be seen from the graph of FIG. 5 that the output common noise would be improved with an increase in the area (i.e., the radius) of the branched electrically-conductive pad 230.

In conclusion, the invention provides a capacitance-compensated differential circuit line layout structure for use on a circuit board, which is characterized by the provision of a branched electrically-conductive pad at the bent portion of the radially-side one of a pair of differential circuit lines (i.e., the shorter one of these two circuit lines), for the purpose of providing the shorter one of the circuit lines with a capacitive effect that can cause a time delay to the UHF digital signal passing therethrough, thereby eliminating the undesired effects of phase skew and signal reflection as in the case of the prior art. In addition, this feature also allows the layout work of the differential pair of circuit lines to be more simplified and thus easier to implement than the prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A capacitance-compensated differential circuit line layout structure for use on a circuit board for the layout of a pair of differential circuit lines on the circuit board, which comprises:
a pair of differential circuit lines, including a first circuit line and a second circuit line, which extend over the circuit board in a curved path and thus include at least one bent portion, wherein the first circuit line is laid radially inside the second circuit line at each bent portion; and
at least one branched electrically-conductive pad, which is laid beside the bent portion of the first circuit line and electrically connected to the first circuit line for providing an equivalent capacitive effect to the first circuit line.

2. The capacitance-compensated differential circuit line layout structure of claim 1, wherein the circuit board is a high-speed digital circuit board for UHF (Ultra-High Frequency) applications.

3. The capacitance-compensated differential circuit line layout structure of claim 1, wherein the differential circuit line pair is a pair of microstrips used for the transmission of differential UHF (Ultra-High Frequency) digital signals.

4. The capacitance-compensated differential circuit line layout structure of claim 1, wherein the branched electrically-conductive pad is formed in a rounded shape.
